(19) United States
(12) Patent Application Publication
(10) Pub. No.: US 2021/0295341 A1
(43) Pub. Date: Sep. 23, 2021

(54) System and Methods for User Authentication in a Retail Environment

(71) Applicant: Adroit Worldwide Media, Inc., Aliso Viejo, CA (US)

(72) Inventors: Greg Schumacher, Aliso Viejo, CA (US); Kevin Howard, Aliso Viejo, CA (US); Matt Maslin, Aliso Viejo, CA (US)

(21) Appl. No.: 17/145,290

(22) Filed: Jan. 9, 2021

Related U.S. Application Data
(60) Provisional application No. 62/959,472, filed on Jan. 10, 2020.

(51) Int. Cl. G06Q 20/40; G06F 21/32; G06F 21/40; G06Q 10/08; G06Q 20/20; G06N 20/00; G06K 9/00; G10L 17/06; H04N 5/247; H04R 1/40; H04R 3/00; G10L 17/24

(52) U.S. Cl. CPC G06Q 20/40145; G06F 21/32; G06F 21/40; G06Q 10/087; G06Q 20/203; G06N 20/00; H04R 2201/401; G10L 17/06; H04N 5/247; H04R 1/406; H04R 3/005; G10L 17/24; G06K 9/00288

(57) ABSTRACT

An automated inventory intelligence system and methods are provided for authenticating identities of customers to facilitate expedited user purchases. The automated inventory intelligence system includes a facial recognition logic for analyzing one or more captured images of a customer, and a voice recognition logic for analyzing voice samples. Customers may be identified using customer matching logic. The facial recognition logic receives multiple views of the customer with a multiplicity of facial recognition cameras coupled with a retail shelving unit. The voice recognition module receives multiple voice samples with a multiplicity of microphones that may be coupled with the retail shelving unit. Customers may be matched with a corresponding customer account to facilitate purchases at the shelving unit based on payment information associated with the customer account.

### PRIORITY

This application claims the benefit of and priority to U.S. Provisional Application No. 62/959,472, filed Jan. 10, 2020, which is incorporated in its entirety herein.

### FIELD

The embodiments of the present disclosure generally relate to retail merchandising and purchasing systems. More particularly, the embodiments relate to authenticating facial and voice characteristics of users to expedite user payments in retail environments.

### BACKGROUND

Retail environments are ever challenging. Consumers typically are confronted with pricing and information about a continuously increasing number of competitors and brands, including information about pricing, labeling, promotions, and the like. Traditionally, customers encounter several obstacles when shopping in-person in retail environments. For example, a customer generally faces obstacles during their shopping experience between entering and leaving a retail store. These obstacles typically include selecting products from a vast array of products, checking out with the selected products, providing payment for the selected products, and other similar inconvenient and inefficient obstacles. However, as retail stores become more streamlined, many consumers are increasingly favoring options that reduce the number of obstacles between the start and end of their shopping experiences. This has led to a growing number of customers turning to online shopping for their day-to-day shopping experiences and purchases.

In addition, customers often enter a retail store or location with a limited amount of time to purchase particular products. However, when customers want to purchase such products at retail stores, the customers may often encounter various inefficient and time-consuming obstacles in relation to the sale and purchase of such products. These inefficient and time-consuming obstacles include: (i) requiring the customers to carry one or more forms of payment, such as credit cards, cash, checks, and so on; (ii) regularly requiring in-person reviews of the customers' form of payment at checkout/payment areas of the stores with their cashier personnel, and (iii) requiring some customers to carry forms of identification (ID) to further demonstrate proof of identify prior to checking out. Therefore, there is an ongoing need for retailers to increase operational efficiencies, create intimate customer experiences, streamline processes, and provide real-time understanding of customer behavior in their stores.

### BRIEF DESCRIPTION OF THE DRAWINGS

The above, and other, aspects, features, and advantages of several embodiments of the present disclosure will be more apparent from the following description as presented in conjunction with the following several figures of the drawings. The drawings refer to embodiments of the present disclosure in which:

FIG. 1 provides an illustration of an automated inventory intelligence system, in accordance with an embodiment of the present disclosure;

FIG. 2A provides a second illustration of a plurality of shelves with an automated inventory intelligence system, in accordance with an embodiment of the present disclosure;

FIG. 2B provides an illustration of a mount of an inventory camera, in accordance with an embodiment of the present disclosure;

FIG. 2C provides an illustration of an inventory camera positioned with respect to a mount of an automated inventory intelligence system, in accordance with an embodiment of the present disclosure;

FIG. 3 provides a second illustration of a plurality of shelves with an automated inventory intelligence system, in accordance with an embodiment of the present disclosure;

FIG. 4 provides an illustration of a portion of an automated inventory intelligence system, in accordance with an embodiment of the present disclosure;

FIG. 5 provides an illustration of an image captured by a camera of an automated inventory intelligence system, in accordance with an embodiment of the present disclosure;

FIG. 6A provides a schematic illustrating a sensor coupled to a retail shelving unit, in accordance with an embodiment of the present disclosure;

FIG. 6B provides a schematic illustrating a sensor such as an inventory camera coupled to an automated inventory intelligence system, in accordance with an embodiment of the present disclosure;

FIG. 6C provides a schematic illustrating a sensor such as an inventory camera coupled to an automated inventory intelligence system, in accordance with an embodiment of the present disclosure;

FIG. 7A provides an exemplary embodiment of a first logical representation of an automated inventory intelligence system, in accordance with an embodiment of the present disclosure;

FIG. 7B provides an exemplary embodiment of a second logical representation of an automated inventory intelligence system, in accordance with an embodiment of the present disclosure; and

FIG. 8 provides a flowchart illustrating an exemplary method for authenticating the identities of retail customers to facilitate expedited user purchases via an automated inventory intelligence system, in accordance with an embodiment of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first shelf,” may be made. However, the specific numeric reference should not be interpreted as a literal sequential order but rather interpreted that the “first shelf” is different than a “second shelf.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and a method for an automated inventory intelligence system that provides intelligence in tracking inventory on, for example retail shelves, as well intelligence in determining the proximity of retail customers as they approach, stall, dwell and/or pass a particular retail shelf or display and the demographics of the retail customers. Further, the automated inventory intelligence system includes intelligence in authenticating the identities of retail customers to facilitate expedited user purchases. In one embodiment, the automated inventory intelligence system is comprised of a cabinet display top, fascia, a proximity sensor, one or more inventory sensors, and one or more demographic tracking sensors.

The cabinet display top can be configured to display animated and/or graphical content and is mounted on top of in-store shelves. In many embodiments, the fascia may include one or more panels of light-emitting diodes (LEDs) configured to display animated and/or graphical content and to mount to an in-store retail shelf. It would be understood by those skilled in the art that other light-emitting technologies may be utilized that can provide sufficient brightness, resolution, contrast, and/or color response. The automated inventory intelligence system can also include a data processing system comprising a media player that is configured to simultaneously execute (i.e., “play”) a multiplicity of media files that are displayed on the cabinet display top and/or the fascia. The cabinet display top and the fascia are typically configured to display content so as to entice potential customers to approach the shelves, and then the fascia may switch to displaying pricing and other information pertaining to the merchandise on the shelves once a potential customer approaches the shelves. The proximity sensor is configured to detect the presence of potential customers. Further, one or more inventory sensors may be configured to track the inventory stocked on one or more in-store retail shelves. The automated inventory intelligence system may create one or more alerts once the stocked inventory remaining on the shelves is reduced to a predetermined minimum threshold quantity.

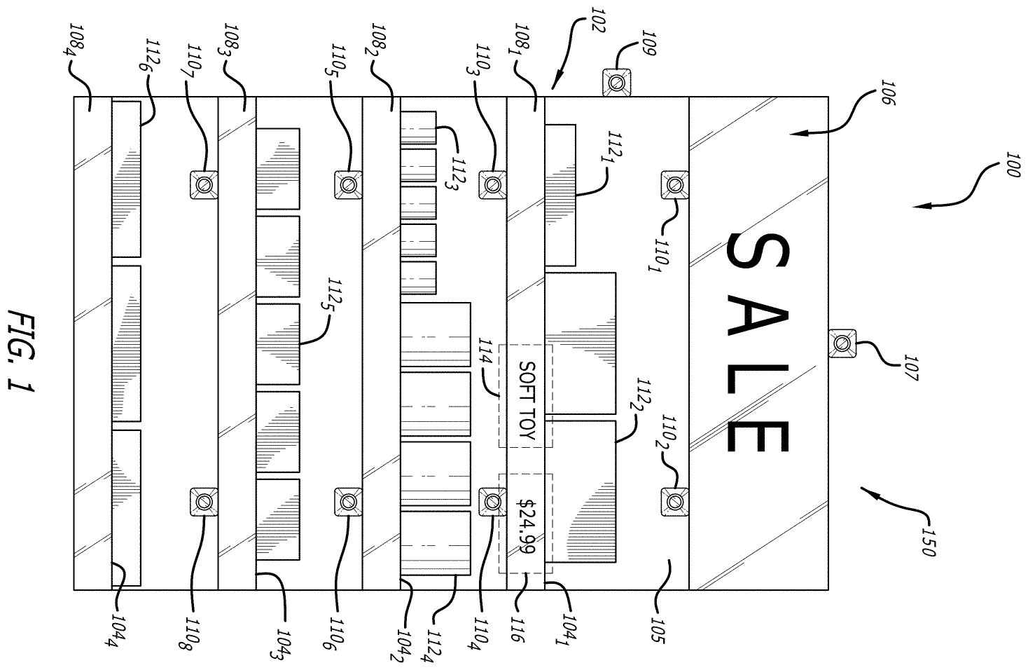

Turning now to FIG. 1, an illustration of an automated inventory intelligence system 100 in accordance with some embodiments is shown. The automated inventory intelligence system 100 comprises a proximity camera 107, fascia 108₁-108₄, a plurality of inventory cameras 110₁-110ᵢ (wherein i≥1, herein, i=8) and a facial recognition camera 109. It is noted that the disclosure is not limited to the automated inventory intelligence system 100 including a single cabinet display top 106 but may include a plurality of cabinet display tops 106. Additionally, the automated inventory intelligence system 100 is not limited to the number of fascia, shelving units, proximity cameras, facial recognition cameras and/or inventory cameras shown in FIG. 1. In typical embodiments, the automated inventory intelligence system 100 couples to a shelving unit 102, which often includes shelves 104, a back component 105 (e.g., pegboard, gridwall, slatwall, etc.) and a cabinet display top 106.

In many embodiments, the cabinet display top 106 is coupled to an upper portion of the shelving unit 102, extending vertically from the back component 105. Further, a proximity camera 107 may be positioned on top of, or otherwise affixed to, the cabinet display top 106. Although the proximity camera 107 is shown in FIG. 1 as being centrally positioned atop the cabinet display top 106, the proximity camera 107 may be positioned in different locations, such as near either end of the top of the cabinet display top 106, on a side of the cabinet display top 106 and/or at other locations coupled to the shelving unit 102 and/or the fascia 108.

The cabinet display top 106 and fascia 108 may be attached to the shelves 104 by way of any fastening means deemed suitable, wherein examples include, but are not limited or restricted to, magnets, adhesives, brackets, hardware fasteners, and the like. In a variety of embodiments, the fascia 108 and the cabinet display top 106 may each be comprised of one or more arrays of light emitting diodes (LEDs) that are configured to display visual content (e.g., still or animated content), with optional speakers, not shown, coupled thereto to provide audio content. Any of the fascia 108 and/or the cabinet display top 106 may be comprised of relatively smaller LED arrays that may be coupled together so as to tessellate the cabinet display top 106 and the fascia 108, such that the fascia and cabinet display top desirably extend along the length of the shelves 104. The smaller LED arrays may be comprised of any number of LED pixels, which may be organized into any arrangement to conveniently extend the cabinet display top 106 and the fascia 108 along the length of a plurality of shelves 104. In some embodiments, for example, a first dimension of the smaller LED arrays may be comprised of about 132 or more pixels. In some embodiments, a second dimension of the smaller LED arrays may be comprised of about 62 or more pixels.

The cabinet display top 106 and the fascia 108 may be configured to display visual content to attract the attention of potential customers. As shown in the embodiment of FIG. 1, the cabinet display top 106 may display desired visual content that extends along the length of the shelves 104. The desired content may be comprised of a single animated or graphical image that fills the entirety of the cabinet display top 106, or the desired content may be a group of smaller, multiple animated or graphical images that cover the area of the cabinet display top 106. In some embodiments, the fascia 108 may cooperate with the cabinet display top 106 to display either a single image or multiple images that appear to be spread across the height and/or length of the shelves 104.

In some embodiments, the cabinet display top 106 may display visual content selected to attract the attention of potential customers to one or more products comprising inventory 112 (e.g., merchandise) located on the shelves 104. Thus, the visual content shown on the cabinet display top 106 may be specifically configured to draw the potential customers to approach the shelves 104 and is often related to the specific inventory 112 located on the corresponding shelves 104. A similar configuration with respect to visual content displayed on the fascia 108 may apply as well, as will be discussed below. The content shown on the cabinet display top 106, as well as the fascia 108, may be dynamically changed to engage and inform customers of ongoing sales, promotions, and advertising. As will be appreciated, these features offer brands and retailers a way to increase sales locally by offering customers a personalized campaign that may be easily changed quickly.

Moreover, as referenced above, portions of the fascia 108 may display visual content such as images of brand names and/or symbols representing products stocked on the shelves 104 nearest to each portion of the fascia. For example, in an embodiment, a single fascia 108 may be comprised of a first inventory portion 114 and a second inventory portion 116. The first inventory portion 114 may display an image of a brand name of inventory 112 that is stocked on the shelf above the first inventory portion 114 (e.g., in one embodiment, stocked directly above the first inventory portion 114), while the second inventory portion 116 may display pricing information for the inventory 112. Additional portions may include an image of a second brand name and/or varied pricing information when such portions correspond to inventory different than inventory 112. It is contemplated, therefore, that the fascia 108 extending along each of the shelves 104 may be sectionalized to display images corresponding to each of the products stocked on the shelves 104. It is further contemplated that the displayed images will advantageously simplify customers quickly locating desired products.

In an embodiment, the animated and/or graphical images displayed on the cabinet display top 106 and the fascia 108 are comprised of media files that are executed by way of a suitable media player. The media player preferably is often configured to simultaneously play any desired number of media files that may be displayed on the smaller LED arrays. In some embodiments, each of the smaller LED arrays may display one media file being executed by the multiplayer, such that a group of adjacent smaller LED arrays combine to display the desired images to the customer. Still, in some embodiments, base video may be stretched to fit any of various sizes of the smaller LED arrays, and/or the cabinet display top 106 and fascia 108. It should be appreciated, therefore, that the multiplayer disclosed herein enables implementing a single media player per aisle in-store instead relying on multiple media players dedicated to each aisle.

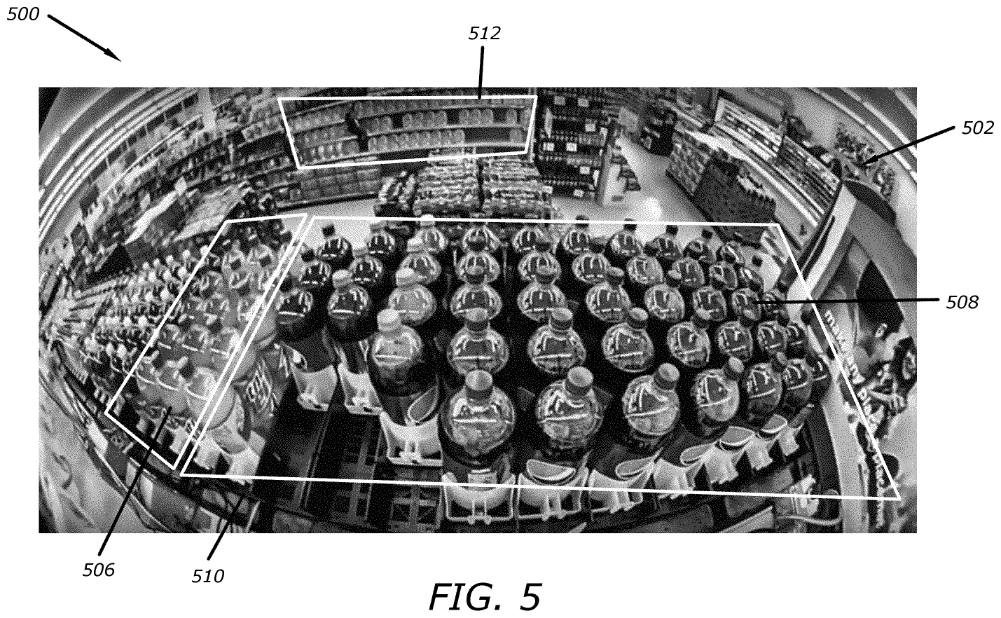

Furthermore, FIG. 1 illustrates a plurality of inventory cameras 110 (i.e., the inventory cameras 110₁-110₈). In some embodiments, the inventory cameras 110 are coupled to the shelving unit 102 (e.g., via the pegboard 105) and positioned above merchandise 112, also referred to herein as “inventory.” Each of the inventory cameras 110 can be configured to monitor a portion of the inventory stocked on each shelf 104, and in some instances, may be positioned below a shelf 104, e.g., as is seen with the inventory cameras 110₃-110₈. However, in some instances, an inventory camera 110 may not be positioned below a shelf 104, e.g., as is seen with the inventory cameras 110₁-110₂. Taking the inventory camera 110₄, as an example, the inventory camera 110₄ is positioned above the second inventory portion 116 and therefore capable of (and configured to), monitor second inventory portion 116. Although, it should be noted that the inventory camera 110₄ may have a viewing angle of 180° (degrees) and is capable of monitoring a larger portion of the inventory 112 on the shelf 104₂ than merely the second inventory portion 116. For example, FIG. 5 illustrates one exemplary image captured by an inventory camera having a viewing of 180°.

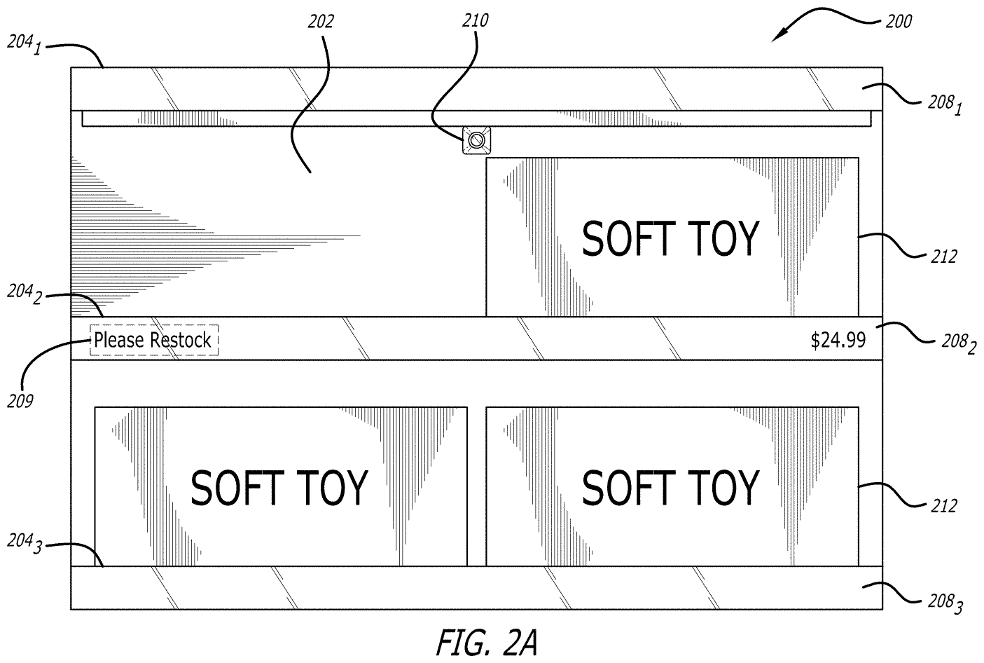

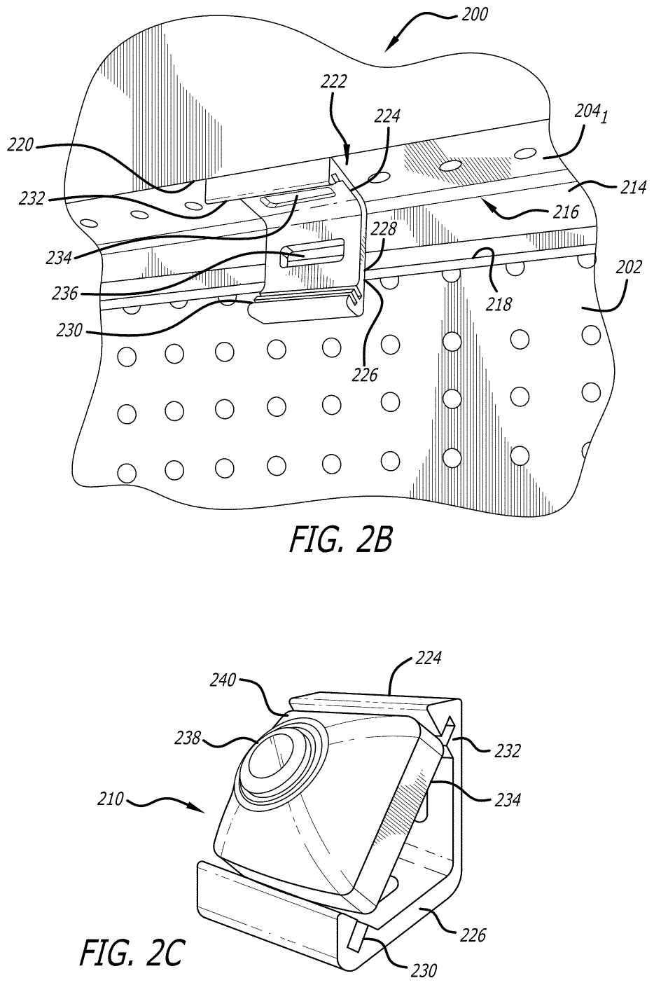

As is illustrated in FIGS. 2A-C, 3-4, and 6A-6C and discussed with respect thereto, the positioning of the inventory cameras 110 may differ from the illustration of FIG. 1. In addition to being positioned differently with respect to spacing above inventory 112 on a particular shelf 104, the inventory cameras 110 may be affixed to the shelving unit 102 in a variety of manners, including attachment to various types of shelves 104 and monitoring of any available inventory 112 stored thereon.

In addition to the proximity camera 107 and the inventory cameras 110₁-110₈, various embodiments of the automated inventory intelligence system 100 can also include a facial recognition camera 109. In one embodiment, the facial recognition camera 109 may be coupled to the exterior of the shelving unit 102. In some embodiments, the facial recognition camera 109 may be positioned approximately five to six feet from the ground in order to obtain a clear image of the faces of a majority of customers. The facial recognition camera 109 may be positioned approximately at heights other than five to six feet from the ground. The facial recognition camera 109 need not be coupled to the exterior of the shelving unit 102 as illustrated in FIG. 1; instead, the illustration of FIG. 1 is merely one embodiment. The facial recognition camera 109 may be coupled to in the interior of a side of the shelving unit 102 as well as to any portion of any of the shelves 104₁-104₄, the cabinet display top 106, the fascia 108 and/or the back component 105 of the shelving unit 102. Further, a plurality of facial recognition cameras 109 may be coupled to the shelving unit 102. In certain embodiments, the facial recognition camera 109 may be eliminated and its associated functions accomplished by any available proximity cameras 107. In these embodiments, software can be utilized to account for any discrepancy between the image and angles captured between the proximity cameras 107 as compared to the facial recognition cameras 109. In further embodiments, especially where privacy concerns are heightened, facial recognition cameras may be eliminated leaving the automated inventory intelligent system 100 to gather customer data by other means including, but not limited to, mobile phone signals/application data and/or radio-frequency identification (RFID) signals.

In some embodiments, the automated inventory intelligence system 100 may include an automated inventory intelligence server 150 and may also include one or more processors, a non-transitory computer-readable memory, one or more communication interfaces, and logic stored on the non-transitory computer-readable memory. For example, the images or other data captured by the proximity camera 107 (or a proximity sensor), the facial recognition camera 109 and/or the inventory cameras 110₁-110₈ may be analyzed by the logic of the automated inventory intelligence system 100. The non-transitory computer-readable medium may be local storage, e.g., located at the store in which the proximity camera 107, the facial recognition camera 109 and/or the inventory cameras 110₁-110₈ reside, or may be cloud-computing storage. Similarly, the one or more processors may be local to the proximity camera 107, the facial recognition camera 109 and/or the inventory cameras 110₁-110₈ or may be provided by cloud computing services.

In some embodiments, the automated inventory intelligence system 100 may include the automated inventory intelligence server 150 to be configured for authenticating the identities of retail customers to facilitate expedited user purchases. Preferably, the automated inventory intelligence system 100 in conjunction with the automated inventory intelligence server 150 may be configured to use a combination of facial recognition and voice recognition techniques to determine the identity of a retail customer. In some embodiments, a multiplicity of facial recognition cameras 109 may be coupled with the shelving unit 102 and arranged to capture multiple views of the retail customer. Further, a multiplicity of microphones may be coupled with the shelving unit 102 and arranged into an advantageous microphone geometry for capturing the voice of the retail customer. The voice recognition may be performed upon the retail customer speaking a training phrase or a spoken user password, whereby the voice verification can be performed. It is contemplated that the automated inventory intelligence system 100 is configured to match the authentication of the voice of the retail customer with the authentication of the face of the retail customer. Thus, the combination of facial recognition and voice recognition of the automated inventory intelligence system 100 comprises a two-stage authentication. It is envisioned, however, that in some embodiments each of the facial recognition and the voice recognition may include one or more layers of authentication, as desired, and without limitation.

It is contemplated that, in some embodiments, a user, such as a retail customer, may establish an account (or a customer account) with a retailer, whereby the user may deposit monetary funds into the account and then later use the funds to perform purchases from the retailer by way of the retail environment, as described herein. As such, upon the user arriving at the shelving unit 102, the automated inventory intelligence system 100 in conjunction with the automated inventory intelligence server 150 may perform the facial recognition and pair/match it with the voice recognition to determine the identity of the user. Once the user is identified, the automated inventory intelligence system 100 and/or automated inventory intelligence server 150 may provide authentication and make the user's account accessible to the user, whereby the user may perform expedited purchases directly at the shelving unit 102, drawing upon the funds stored in the user's account, as described below in further detail.

In many embodiments, the automated inventory intelligence server 150 may comprise one or more of servers, networks, and cloud/edge servers. In some embodiments, the automated inventory intelligence system 100 and/or automated inventory intelligence server may be entirely contained within a retail environment, such as a retail store or the like. In certain embodiments, the automated inventory intelligence system/server 100/150 may be installed in multiple stores and may have its operations be supplemented by facilitating a communication link between the multiple stores. Examples of the environment in which the automated inventory intelligence system 100 may be located include, but are not limited or restricted to, a retailer, a warehouse, an airport, a high school, college or university, any cafeteria, a hospital lobby, a hotel lobby, a train station, or any other area in which a shelving unit for storing inventory may be located. Additionally, in some embodiments, examples of the environment in which the automated inventory intelligence system 100 may be located may include a variety of consumer environments, such as, but not limited to, a retail store, a package store, a grocery store, a liquor store, a store locker/cooler, a convenient store, a pharmacy store, a supermarket store, a wholesale warehouse retailer, a hypermarket, a discount department store, and/or any other types of stores that sale goods and services. In some embodiments, the stores may comprise one or more intelligent shelves described herein.

In some embodiments, the automated inventory intelligence server 150 may be utilized to add such functionality to a pre-existing system and/or installation, such as the automated inventory intelligence server 100 or the like. By way of a non-limiting example, the automated inventory intelligence server 150 may receive data from the intelligent shelves including, but not limited to, image data captured from the sensors/cameras on the intelligent shelves within the store and transmit the data over the network to the automated inventory intelligence server 150 for processing and inventory, customer, and probability data generation which may then be either further processed by the automated inventory intelligence server 150 or may be transmitted back to the store for further processing. In this way, the automated inventory intelligence server 150 may be marketed as a service that may be added on to stores with existing hardware that may facilitate the automated inventory intelligence system 100.

In further embodiments, the automated inventory intelligence system 100 may utilize one or more networks, such as the Internet to facilitate a remote connection to other devices that may supplement and/or aid the function of such system. In certain embodiments, the automated inventory intelligence system 100 may utilize the automated inventory intelligence server 150 to provide data processing, storage, and/or retrieval required for such system. In some embodiments, the automated inventory intelligence server 150 may be utilized for a variety of purposes including, but not limited to, updating data within a store-located automated inventory intelligence system, providing updated inventory data, providing updated pricing data, receiving new promotional data, and/or providing new and updated customer data such as new/updated customer accounts with new/updated personal data, payment data, and so on. It should be understood that the automated inventory intelligence server 150 may be utilized by the automated inventory intelligence system 100 to update or supplement any type of data, without limitation.

In other embodiments, portions of the automated inventory intelligence system may be served by the use of one or more cloud/edge servers from a third party. It should be understood that the use of cloud/edge servers and/or any other similar cloud computing devices/systems may allow for both increased data delivery and transmission speeds, as well as ease of scalability should the automated inventory intelligence system be implemented quickly over a large area or number of stores. In some embodiments, the cloud/edge server may facilitate many aspects of the automated inventory intelligence system up to providing the entire automated inventory intelligence processing necessary for implementation. By way of a non-limiting example, the cloud/edge server may be used to implement most, if not all, of the data stores necessary for such systems described herein. In additional embodiments, the cloud/edge server may provide or supplement image processing capabilities in conjunction with the image processing capabilities of the automated inventory intelligence server 150, and/or may provide ground truth data with a variety of machine learning, predetermined rule sets, and/or deep convolutional neural networks.

In some embodiments, the automated inventory intelligence server 150 may be configured to provide data processing, storage, and/or retrieval required for the automated inventory intelligence system and/or any other component of the automated inventory intelligence system network. The automated inventory intelligence server 150 may be implemented to provide customer data used to enable authentication and make an account of the retail customers in the stores accessible to the particular identified/authenticated customer. In the embodiments, the customer data may be comprised of a plurality of data inputs related to one or more customers, including, but not limited to, name, address, date of birth, gender, height, weight, form of ID, ID number, ID expiration date, ID issue date, ID issuing state, high resolution images of both sides of the ID, customer facial image, customer voice recording, detailed payment information (e.g., credit card number, expiration date, security code, etc.), contact information, customer password or pin number, and/or any other desired customer data input.

Accordingly, when a customer visits any of the retail environments described herein, the automated inventory intelligence system 100—in conjunction with the automated inventory intelligence server 150—may implement one or more facial and/or voice matching recognition techniques to identify the customer in one of the retail environments/stores. For example, in some embodiments, in response to accurately identifying the customer in the store, the automated inventory intelligence system 100 may be configured to communicate with the automated inventory intelligence server 150 via a network to determine: (i) whether the identified customer has enrolled their payment information in such server (or the like); (ii) if the customer is enrolled, whether the identified customer and/or their enrolled payment information has been properly authenticated and/or verified, such that the customer has provided the necessary information needed to purchase products within the store; and/or (iii) if the customer has been authenticated and their respective account been made accessible to the respective customer, whether the payment information is still valid, active (i.e., not past the expiration date), in good standing, and so on, based on one or more predetermined rules. Subsequently, after the proper determinations are established via the automated inventory intelligence server 150 such as authenticating the facial and/or voice sample of the identified customer, the automated inventory intelligence system 100 may then enable the identification and authentication of retail customers to facilitate expedited customer purchases in the respective environment/store. In such embodiments, the expedited customer purchase allows the customer to pick up the respective product in the store and leave the store with the product, without needing to provide any payment information before leaving the store, needing an in-person review of such payment information at a checkout area of the store, and/or needing to provide any additional related customer and/or payment information when the customer leaves the store.

Turning now to FIG. 2A, a second illustration of a plurality of shelves with an automated inventory intelligence system in accordance with some embodiments is shown. Specifically, FIG. 2A illustrates the automated inventory intelligence system coupled to a shelving unit 200. More particularly, the shelving unit 200 includes a back component 202 (e.g., pegboard) and shelves 204 (wherein shelves 204₁-204₃ are illustrated; however, the shelving unit 200 may include additional shelves). In the illustrated embodiment, the automated inventory intelligence system includes fascia 208 and the inventory sensor 210 (herein the inventory sensor 210 is depicted as inventory camera). Although only a single inventory camera 210 is shown in FIG. 2A, the automated inventory intelligence system may include additional inventory cameras not shown. FIG. 2A provides a clear perspective as to the positioning of the inventory camera 210 may be in one embodiment. Specifically, the inventory camera 210 is shown to be coupled to a corner formed by an underside of the shelf 204₁ and the back component 202. The positioning of the inventory camera 210 can enable the inventory camera 210 to monitor the inventory 212. Additional detail of the coupling of the inventory camera 210 to the shelving unit 200 is seen in FIG. 2B. In addition, the fascia, e.g., fascia 208₂ may display pricing information (as also shown in FIG. 1) as well as display an alert 209, e.g., a visual indicator via LEDs of a portion of the fascia, indicating that inventory stocked on the corresponding shelf, e.g., the shelf 204₂, is to be restocked.

Referring now to FIG. 2B, an illustration of a mount of the inventory camera 210 of FIG. 2A is shown in accordance with some embodiments. The mount 222, which may be “L-shaped” in nature (i.e., two sides extending at a 90° (degree) angle from each other, is shown without the inventory camera 210 placed therein. In some embodiments, the inventory camera 210 may snap into the mount 222, which may enable inventory cameras to be easily replaced, moved, removed for charging or repair, etc. The mount 222 is shown as being coupled to a corner formed by an underside of the shelf 2041 and the back component 202. In particular, the shelving unit 200 depicted in FIG. 2B comprises a first metal runner 214 attached to the back component 202 and a second metal runner 220 is shown as being attached to the underside of the shelf 204₁. The first metal runner 214 includes a first groove 216 and a second groove 218 to which flanges of the mount 222, such as the flange 228, may slide or otherwise couple. Although not shown, a groove is also formed by the second metal runner 220, which may also assist in the coupling of the mount 222.

In the embodiment illustrated, the mount 222 includes a top component 224, a side component 226, an optional flange 228, bottom grips 230, top grips 232, a top cavity 234 and side cavity 236. In addition, although not shown, a flange extending from the top component 224 to couple with the second metal runner 220 may be included. The inventory camera 210 may couple to the mount 222 and be securely held in place by the bottom grips 230 and the top grips 232. Further, the body of the inventory camera 210 may include projections that couple, e.g., mate, with the top cavity 234 and/or the side cavity 236 to prevent shifting of the inventory camera 210 upon coupling with the mount 222.

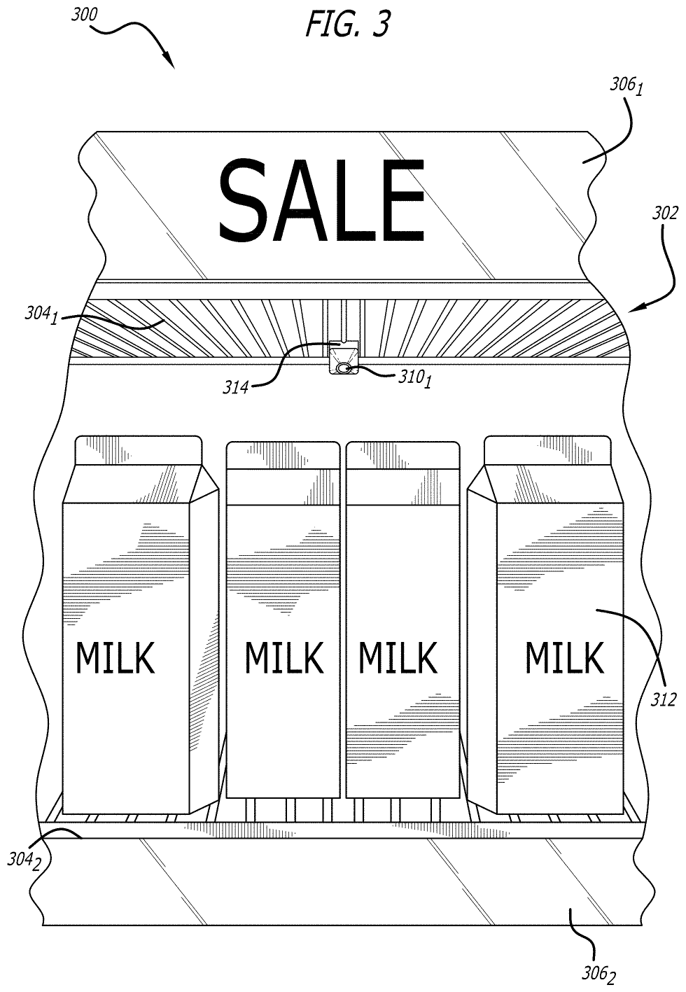

Referring to FIG. 2C, an illustration of the inventory camera 210 positioned within the mount 222 of the automated inventory intelligence system of FIGS. 2A-B is shown. The inventory camera 210 is positioned within the mount 222 and includes a lens 238 and a housing 240. The inventory camera 210 is shown as having four straight sides but may take alternative forms as still be within the scope of the invention. For example, in other embodiments, the inventory camera 210 may only have two straight sides and may include two curved sides. Additionally, the inventory camera 210 may take a circular shape or include one or more circular arcs. Further, the inventory camera 210 may take the form of any polygon or other known geometric shape. In addition, the housing 240 may have an angled face such that the face of the housing 240 slopes away from the lens 238, which may be advantageous in capturing an image having a viewing angle of 180°. The inventory camera 210 may snap into the mount 222 and held in place by friction of the bottom grips 230 and top grips 232, and the force applied by the top component 224 and the side component 226. It would be understood to those skilled in the art that the mount 222 can comprise a variety of shapes depending on the camera and shelving unit 200 being utilized, as can be shown in the camera mount depicted in FIG. 3 below.

Referring now to FIG. 3, a second illustration of a plurality of shelves with an automated inventory intelligence system is shown in accordance with some embodiments. In particular, FIG. 3 illustrates an inventory camera 310₁ of the automated inventory intelligence system 300 coupled to the underside of a shelf 304₁, which is part of the shelving unit 302. In the embodiment depicted in FIG. 3, the automated inventory intelligence system 300 includes the fascia 306₁-306₂, the inventory camera 310₁ and a mount 314. In one embodiment, the mount 314 is coupled to underside of shelf 3041, which is possible due to the configuration of the shelf 304₁, particularly, the shelf 304₁ is comprised of a series of grates. Due to the grated nature of the shelf 304₁, the mount 314 may be configured to clip directly to one or more of the grates.

It should also be noted that the shelving unit 302 is refrigerated, e.g., configured for housing milk, and includes a door, not shown. As a result of being refrigerated, the shelving unit 302 experiences temperature swings as the door is opened and closed, which often results in the temporary accumulation of condensation on the lens of the inventory camera 310₁. Thus, the logic of the automated inventory intelligence system may perform various forms of processing for handling the temporary accumulation of condensation on the lens of the inventory camera 310₁, which may include, for example, (i) sensing when the door of the shelving unit 302 is opened, e.g., via sensing activation of a light, and waiting a predetermined amount of time before taking an image capture with the inventory camera 310₁ (e.g., to wait until the condensation has dissipated), and/or (ii) capturing an image with the inventory camera 310₁, performing image processing such as object recognition techniques, and discarding the image when the object recognition techniques do not provide a confidence level of the recognized objects above a predetermined threshold (e.g., condensation blurred or otherwise obscured the image, indicating the presence of condensation).

Although not shown, in one embodiment, the inventory camera 310₁ may be coupled to the front of the shelf 304₁ and face the inventory 312. Such an embodiment may be advantageous with refrigerated shelving units such as the shelving unit 302 when a light source, not shown, is housed within the shelving unit and turns on when a door of the shelving unit is opened. More specifically, when the light source is positioned at the rear of the shelving unit, the image captured by the inventory camera 310₁ may appear clearer and less blurred in such an embodiment.

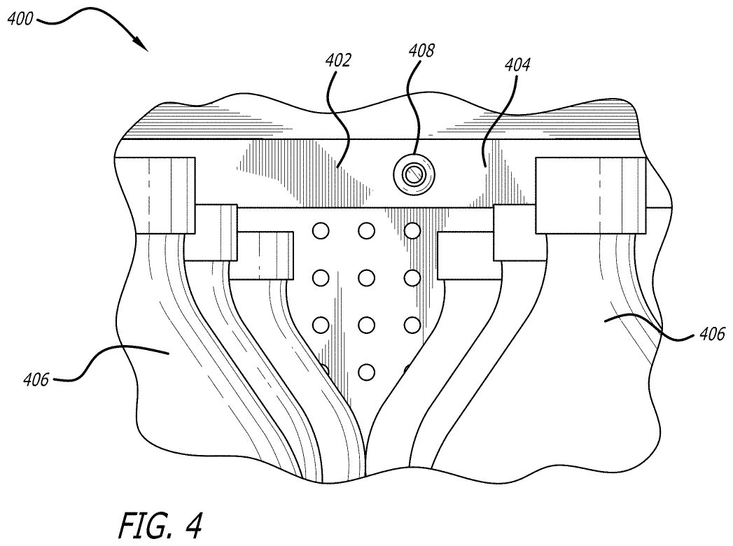

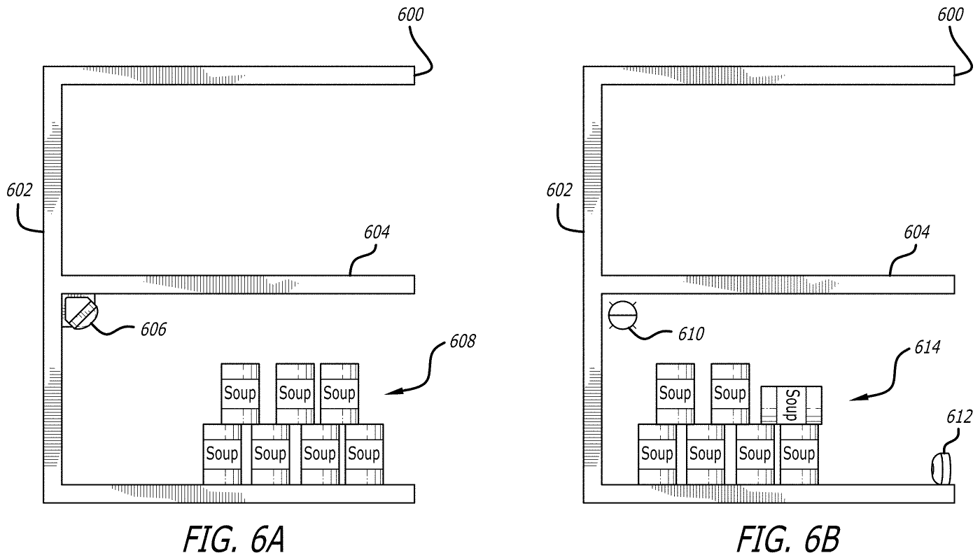

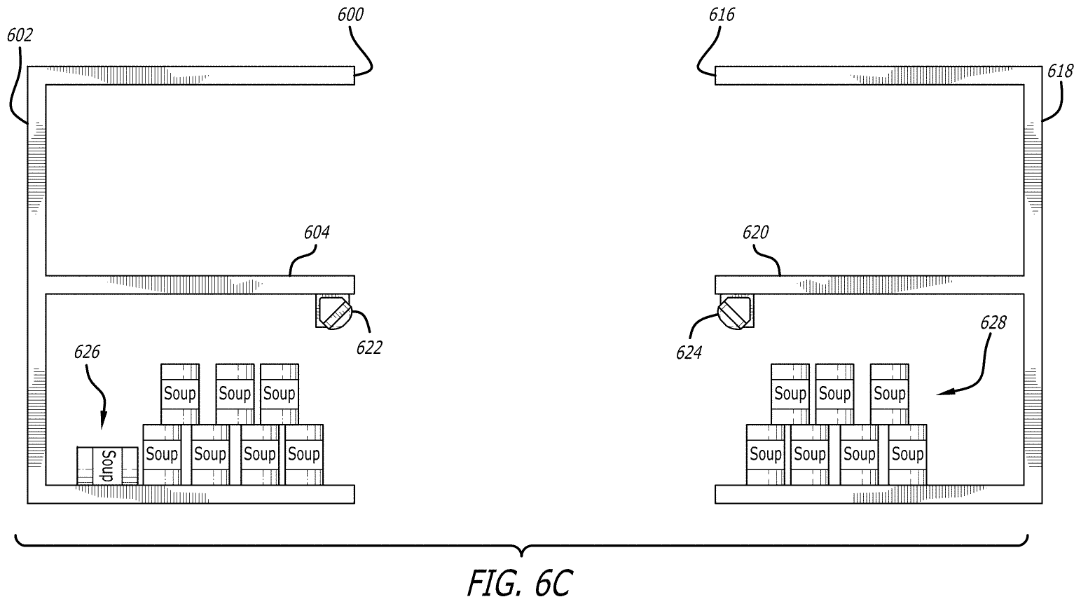

Referring to FIG. 4, an illustration of a portion of an automated inventory intelligence system is shown in accordance with some embodiments. In particular, a sensor 408 is shown positioned near merchandise 406 stocked on a shelving unit 402 of an automated inventory intelligence system 400. The sensor 408 is shown integrated in a housing 404, wherein the housing 404 may, in one embodiment, take the form of a rod that extends along at least a portion of the back component of the shelving unit and may be configured to couple to the shelving unit. As in other embodiments disclosed herein, the sensor 408 may include a digital camera; however, in other embodiments, the sensor 408 may be any sensing device whereby merchandise stocked on a shelving unit may be monitored. In the embodiment shown, the sensor 408 is configured to be coupled directly to the shelving unit 402 by way of any fastening means deemed suitable, such as, by way of non-limiting example, magnets, adhesives, brackets, hardware fasteners, and the like. In other embodiments, such as those illustrated in FIGS. 5-6 below, the sensor 408 may be coupled to the shelving unit 402 through a mounting bracket. Further, the location of a sensor such as the sensor 408 is not to be limited to the location shown in FIG. 4. It should be understood that the sensor 408 may be disposed in any location with respect to a retail display or warehouse storage unit whereby the stocked merchandise may be monitored. Embodiments of some alternative positioning of sensors are illustrated in FIGS. 6A-C. Furthermore, preferred locations suited to receive the sensor 408 will generally depend upon one or more factors, such as, for example, the type of merchandise, an ability to capture a desired quantity of merchandise within the field of view of the sensor 408, as well as the methods whereby customers typically remove merchandise from the retail display units.

Any of the retail displays or warehouse storage units outfitted with the automated inventory intelligence system 400 can monitor the quantity of stocked merchandise by way of one or more sensors such as the sensor 408 and then create a notification or an alert once the remaining merchandise is reduced to a predetermined minimum threshold quantity. For example, low-inventory alerts may be created when the remaining merchandise is reduced to 50% and 20% thresholds; however, the disclosure is not intended to be so limited and thresholds may be predetermined and/or dynamically configurable (e.g., in response to weather conditions, and/or past sales history data). The low-inventory alerts may be sent to in-store staff to signal that a retail display needs to be restocked with merchandise. In some embodiments, the low-inventory alerts can include real-time images and/or stock levels of the retail displays so that staff can see the quantity of merchandise remaining on the retail displays by way of a computer or a mobile device. In some embodiments, the low-inventory alerts may be sent in the form of text messages in real time to mobile devices carried by in-store staff. As will be appreciated, the low-inventory alerts can signal in-store staff to restock the retail displays with additional merchandise to maintain a frictionless shopping experience for consumers. In addition, the automated inventory intelligence system 400 can facilitate deeper analyses of sales performance by coupling actual sales with display shelf activity.

Referring to FIG. 5, an illustration of an image captured by a camera of an automated inventory intelligence system is shown in accordance with some embodiments. The image 500 shown in FIG. 5 illustrates the ability of an inventory camera configured for use with the automated inventory intelligence system of FIGS. 2A-C to capture the image 500 having an approximately 180° viewing angle. In certain embodiments, an inventory camera, such as the inventory camera 310₁ of FIG. 3, may be positioned within a shelving unit, such as the shelving unit 302 of FIG. 3, such that the inventory camera is located at the inner rear of the shelving unit and above a portion of inventory. In such an embodiment, the inventory camera 310₁ may capture an image such as the image 500, which includes a capture of a first inventory portion 508 and a second inventory portion 510 stocked on shelf 506. In addition, the image 500 may include a capture of a portion of the store environment 502 and additional inventory portion 512.

Specifically, the positioning of the inventory camera as shown in FIG. 5 enables the inventory camera to capture images such as the image 500, which may be analyzed by logic of the automated inventory intelligence system to automatically and intelligently determine the amount of inventory stocked on the shelf. For example, as seen in the image 500, the first inventory portion 508 and the second inventory portion 510 may be identified by the automated inventory intelligence system using object recognition techniques. For example, upon recognition of the first inventory portion 508 (e.g., recognition of Pepsi bottles), logic of the automated inventory intelligence system may analyze the quantity remaining on the shelf 506. In additional embodiments, the automated inventory intelligence system may determine whether a threshold number of bottles have been removed from the shelf 506. Upon determining at least the threshold number of bottles have been removed, the automated inventory intelligence system may generate a report and/or an alert notifying employees and/or manufacturers that the first inventory portion 508 requires restocking. In additional embodiments, the automated inventory intelligence system may determine that less than a threshold number of bottles remain on the shelf 506 and therefore the first inventory portion 508 requires restocking. Utilization of other methodologies of determining whether at least a predetermined number of items remain on a shelf for a given inventory set are within the scope of the invention. Herein, the term “inventory set” generally refers to a grouping of a particular item, e.g., a grouping of a particular type of merchandise, which may include brand, product size (12 oz. bottle v. 2 L bottle), etc.

In some embodiments, the image 500 may also be analyzed to determine the remaining items of other inventory portions such as the second inventory portion 510 and/or the additional inventory portion 512. As seen in FIGS. 6A-6C, the inventory camera may be placed at various varying positions within, or coupled to, a shelving unit. The utilization of such alternative configurations may be dependent upon the type of shelving unit, the type of inventory being captured in images taken by the inventory camera and/or the positioning of inventory within the store environment (e.g., across an aisle).

FIGS. 6A-6C provide schematics illustrating sensors coupled to retail displays in accordance with some embodiments. The one or more sensors are configured to be disposed in a retail environment such as by coupling the sensors to retail displays or warehouse storage units. Such retail displays include, but are not limited to, shelves, panels (e.g., pegboard, gridwall, slatwall, etc.), tables, cabinets, cases, bins, boxes, stands, and racks, and such warehouse storage includes, but is not limited to, shelves, cabinets, bins, boxes, and racks. The sensors may be coupled to the retail displays or the warehouse storage units such that one sensor is provided for every set of inventory items (e.g., one-to-one relationship), one sensor for a number of sets of inventory items (e.g., one-to-many relationship), or a combination thereof. The sensors may also be coupled to the retail displays or the warehouse storage units with more than one sensor for every set of inventory items (e.g., many-to-one relationship), more than one sensor for a number of sets of inventory items (e.g., many-to-many relationship), or a combination thereof. In an example of a many-to-one relationship, at least two sensors monitor the same set of inventory items thereby providing contemporaneous sensor data for the set of inventory items. Providing two (or more) sensors for a single set of inventory is useful for sensor data redundancy or simply having a backup. Each of FIGS. 6A-6C shows a one-to-one relationship of a sensor to a set of inventory items, but each sensor can alternatively be in one of the foregoing alternative relationships with one or more sets of inventory items.

The sensors include, but are not limited to, light- or sound-based sensors such as digital cameras and microphones, respectively. In some embodiments, the sensors are digital cameras, also referred to as “inventory cameras,” with a wide viewing angle up to a 180° viewing angle.

Referring now to FIG. 6A, a schematic illustrating a sensor such as a sensor 606 coupled to a retail shelving unit 604 is shown in accordance with some embodiments. As shown, the sensor 606, e.g., an inventory camera, may be coupled to or mounted on the retail shelving unit 604 under an upper shelf of the retail shelving unit 604, wherein the retail shelving unit 604 is a component of the housing 602 of the automated inventory intelligence system 600. In the illustrated embodiment, the inventory camera 606 is configured in an orientation to view a set of inventory items 608 on an inventory item-containing shelf beneath the upper shelf. While the inventory camera 606 is shown mounted inside the retail shelving unit 604 such as on a back (e.g., pegboard) of the housing 602 and looking out from the automated inventory intelligence system 600, the inventory camera 606 may alternatively be coupled to the upper shelf and looking in to the automated inventory intelligence system 600. Due to a wide viewing angle of up to 180°, whether looking out from or into the automated inventory intelligence system 600, the inventory camera 606 may collect visual information on sets of inventory items adjacent to the set of inventory items 608.

Referring to FIG. 6B, a schematic illustrating a sensor such as an inventory camera 612 coupled to an automated inventory intelligence system 600 is shown in accordance with some embodiments. As shown, the inventory camera 612 may be coupled to or mounted on the automated inventory intelligence system 600 on an inventory-item containing shelf of the automated inventory intelligence system 600 in an orientation to view a set of inventory items 614 on the inventory item-containing shelf. While the inventory camera 612 is shown mounted inside the automated inventory intelligence system 600 on the inventory item-containing shelf and looking in to the automated inventory intelligence system 600, which may be advantageous when a light 610 is present in a back of automated inventory intelligence system 600, the inventory camera 612 may alternatively be coupled to the inventory item-containing shelf and looking out from the automated inventory intelligence system 600. Due to a wide viewing angle of up to 180°, whether looking in to or out from the automated inventory intelligence system 600, the inventory camera 612 may collect visual information on sets of inventory items adjacent to the set of inventory items 614.

Referring to FIG. 6C, a schematic illustrating a sensor such as an inventory camera 622 coupled to the automated inventory intelligence system 600 is shown in accordance with some embodiments. In addition, FIG. 6C further provides a second housing 618 with a second sensor such as an inventory camera 624 coupled to a second upper shelf 620 and in communication with a second automated inventory intelligence system 616 in accordance with some embodiments. In certain embodiments the automated inventory intelligence system 600 and second automated inventory intelligence system 616 may be separate and independent systems or may be communicatively coupled and/or processing data cooperatively.

As shown, the inventory camera 622 may be physically coupled to or mounted on the automated inventory intelligence system 600 in an orientation to view a set of inventory items 628 on an inventory-item containing shelf of an opposing shelving unit across an aisle such as the automated inventory intelligence system 616. Likewise, the inventory camera 624 may be coupled to or mounted on the automated inventory intelligence system 616 in an orientation to view a set of inventory items 626 on an inventory-item containing shelf of an opposing shelving unit across an aisle such as the automated inventory intelligence system 600. Due to wide viewing angles of up to 180°, the inventory camera 622 can collect visual information on sets of inventory items on the automated inventory intelligence system 616 adjacent to the set of inventory items 628 (not shown), and the inventory camera 622 can collect visual information on sets of inventory items on the automated inventory intelligence system 616 adjacent to the set of inventory items 626 (not shown).

In some embodiments, inventory cameras such as inventory cameras 606, 612, 622, and 624 are coupled to or mounted on endcaps or other vantage points of the automated inventory intelligence systems to collect visual information while looking into the retail shelving units.

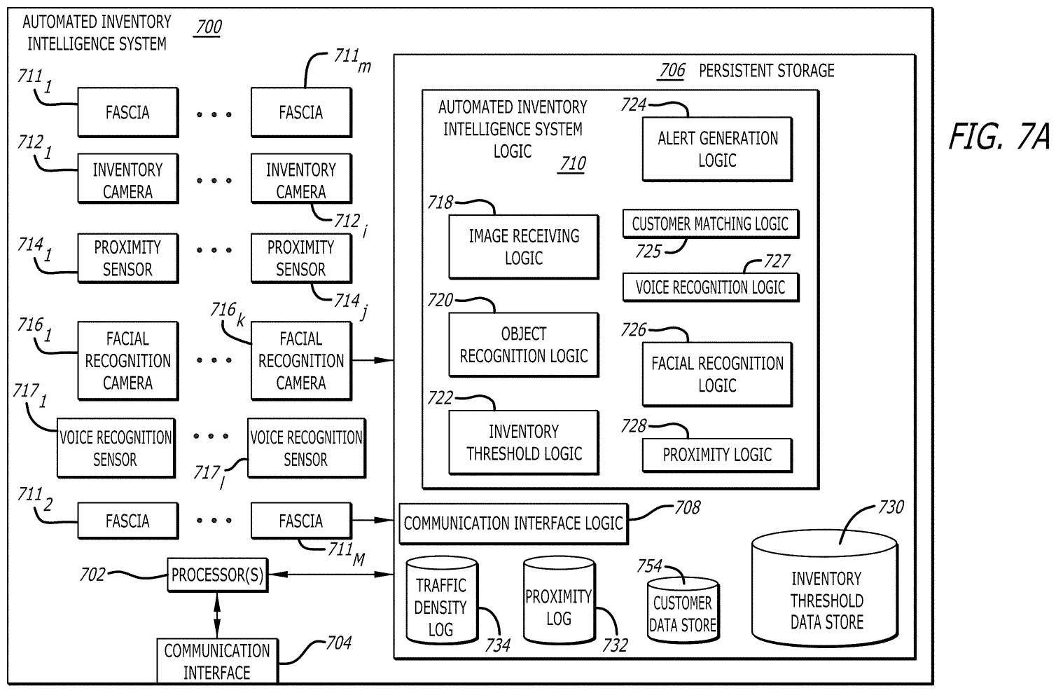

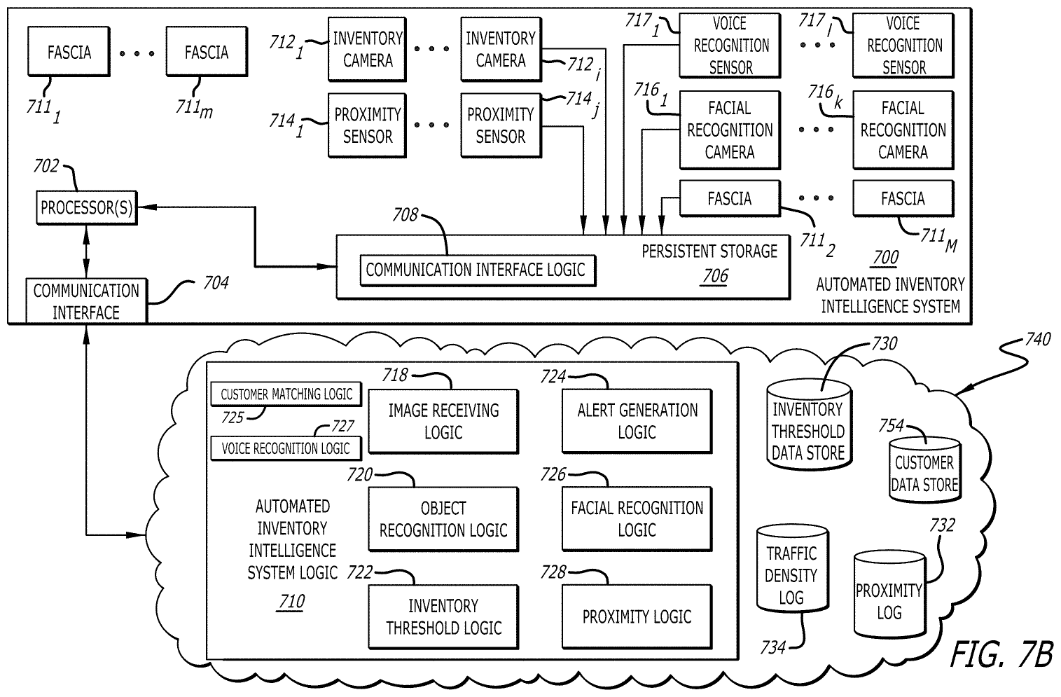

Referring to FIG. 7A, an exemplary embodiment of a first logical representation of the automated inventory intelligence system of FIG. 1 is shown in accordance with some embodiments. In many embodiments, the automated inventory intelligence system 700 may include one or more processors 702 that are coupled to a communication interface 704. The communication interface 704, in combination with a communication interface logic 708, enables communications with external network devices and/or other network appliances transmit and receive data. According to one embodiment of the disclosure, the communication interface 704 may be implemented as a physical interface including one or more ports for wired connectors. Additionally, or in the alternative, the communication interface 704 may be implemented with one or more radio units for supporting wireless communications with other electronic devices. The communication interface logic 708 may include logic for performing operations of receiving and transmitting data via the communication interface 704 to enable communication between the automated inventory intelligence system 700 and network devices via a network (e.g., the internet) and/or cloud computing services, not shown.

The processor(s) 702 is further coupled to a persistent storage 706. According to at least one embodiment of the disclosure, the persistent storage 706 may store logic as software modules includes an automated inventory intelligence system logic 710 and the communication interface logic 708. The operations of these software modules, upon execution by the processor(s) 702, are described above. Of course, it is contemplated that some or all of this logic may be implemented as hardware, and if so, such logic could be implemented separately from each other.

Additionally, the automated inventory intelligence system 700 may include hardware components such as fascia 711₁-711ₘ (wherein m≥1), inventory cameras 712₁-712ᵢ (wherein i≥1), proximity sensors 714₁-714ⱼ (wherein j≥1), facial recognition cameras 716₁-716ₖ (wherein k≥1), and/or voice recognition sensors 717₁-717ₗ (wherein l≥1). Each of the inventory cameras 712₁-712ᵢ, the proximity sensors 714₁-714ⱼ, the facial recognition cameras 716₁-716ₖ, and the voice recognition sensors 717₁-717ₗ may be configured to capture images, e.g., at predetermined time intervals or upon a triggering event, and transmit the images to the persistent storage 706. The automated inventory intelligence system logic 710 may, upon execution by the processor(s) 702, perform operations to analyze the images. In such embodiments, the automated inventory intelligence system logic 710 may determine whether a threshold amount of inventory remains stocked and provide results of the determination configured to alert of a need to restock the inventory, when applicable.

Referring to FIG. 7B, an exemplary embodiment of a second logical representation of the automated inventory intelligence system of FIG. 1 is shown in accordance with some embodiments. The illustration of FIG. 7B provides a second embodiment of the automated inventory intelligence system 700 in which the automated inventory intelligence system logic 710 resides in cloud computing services 740. In such an embodiment, each of the inventory cameras 712₁-712ᵢ, the proximity sensors 714₁-714ⱼ, and the facial recognition cameras 716₁-716ₖ may be configured to capture images, and each of the voice recognition sensors 717₁-717ₗ may be configured to capture voice samples, where the captured images and/or voice samples are then transmitted, via the communication interface 704, to the automated inventory intelligence system logic 710 in the cloud computing services 740. The automated inventory intelligence system logic 710, upon execution via the cloud computing services 740, perform operations to analyze the images.

Processor(s) 702 can represent a single processor or multiple processors with a single processor core or multiple processor cores included therein. Processor(s) 702 can represent one or more general-purpose processors such as a microprocessor, a central processing unit (“CPU”), or the like. More particularly, processor(s) 702 may be a complex instruction set computing (“CISC”) microprocessor, reduced instruction set computing (“RISC”) microprocessor, very long instruction word (“VLIW”) microprocessor, or processor implementing other instruction sets, or processors implementing a combination of instruction sets. Processor(s) 702 can also be one or more special-purpose processors such as an application specific integrated circuit (“ASIC”), a field programmable gate array (“FPGA”), a digital signal processor (“DSP”), a network processor, a graphics processor, a network processor, a communications processor, a cryptographic processor, a co-processor, an embedded processor, or any other type of logic capable of processing instructions. Processor(s) 702 can be configured to execute instructions for performing the operations and steps discussed herein.

Persistent storage 706 can include one or more volatile storage (or memory) devices, such as random access memory (“RAM”), dynamic RAM (“DRAM”), synchronous DRAM (“SDRAM”), static RAM (“SRAM”), or other types of storage devices. Persistent storage 706 can store information including sequences of instructions that are executed by the processor(s) 702, or any other device. For example, executable code and/or data of a variety of operating systems, device drivers, firmware (e.g., input output basic system or BIOS), and/or applications may be loaded in persistent storage 706 and executed by the processor(s) 702. An operating system may be any kind of operating systems, such as, for example, Windows® operating system from Microsoft®, Mac OS®/iOS® from Apple, Android® from Google®, Linux®, Unix®, or other real-time or embedded operating systems such as VxWorks.

In many embodiments, the automated inventory intelligence system logic 710 includes an image receiving logic 718, an object recognition logic 720, an inventory threshold logic 722, an alert generation logic 724, a customer matching logic 725, a facial recognition logic 726, a voice recognition logic 727, and/or a proximity logic 728. In further embodiments, the image receiving logic 718 can be configured to, upon execution by the processor(s) 702, perform operations to receive a plurality of images from a sensor, such as the inventory cameras 712₁-712ᵢ. In some embodiments, the image receiving logic 718 may receive a trigger, such as a request for a determination whether an inventory set needs to be restocked, and request an image be captured by one or more of the inventory cameras 712₁-712ᵢ.

The object recognition logic 720 is configured to, upon execution by the processor(s) 702, perform operations to analyze an image received by an inventory camera 712₁-712ᵢ, including object recognition techniques. In some embodiments, the object recognition techniques may include the use of machine learning, predetermined rule sets and/or deep convolutional neural networks. The object recognition logic 720 may be configured to identify one or more inventory sets within an image and determine an amount of each product within the inventory set. In addition, the object recognition logic 720 may identify a percentage, numerical determination, or other equivalent figure that indicates how much of the inventory set remains on the shelf (i.e., stocked) relative to an initial amount (e.g., based on analysis and comparison with an earlier image and/or retrieval of an initial amount predetermined and stored in a data store, such as the inventory threshold data store 730).

The inventory threshold logic 722 is configured to, upon execution by the processor(s) 702, perform operations to retrieve one or more predetermined thresholds and determine whether the inventory set needs to be restocked. A plurality of predetermined holds, which may be stored in the inventory threshold data store 730, may be utilized in a single embodiment. For example, a first threshold may be used to determine whether the inventory set needs to be stocked and an alert transmitted to, for example, a retail employee (e.g., at least a first amount of the initial inventory set has been removed). In addition, a second threshold may be used to determine whether a product delivery person needs to deliver more of the corresponding product to the retailer (e.g., indicating at least a second amount of the initial inventory set has been removed, the second amount greater than the first amount). In such an embodiment, when the second threshold is met, alerts may be transmitted to both a retail employee and a product delivery person.

The alert generation logic 724 can be configured to, upon execution by the processor(s) 702, perform operations to generate alerts according to determinations made by, for example, the object recognition logic 720 and the inventory threshold logic 722. In certain embodiments, the alerts may take any form such as a digital communication transmitted to one or more electronic devices, and/or an audio/visual cue in proximity to the shelf on which the inventory set is stocked, etc.

In embodiments, the customer matching logic 725 may be utilized for a variety of operations including, but not limited to, determining trends of the customers or gathering data related to the customers based on ethnicity, age, gender, time of visit, geographic location of the store, and so on. Based on additional analysis, the automated system logic 710 may determine trends in accordance with a variety of factors including, but not limited to, graphics displayed by the automated inventory intelligence system 700, sales, time of day, time of the year, day of the week, etc. The customer matching logic 725 (in conjunction with the facial and/or voice recognition logics 726-727 in some embodiments) may be utilized to access customer information and/or accounts within a customer data store 754, to identify a customer recognized within a store based on at least one or more of the captured images and voice samples, to match the identified customer with a customer account associated with the identified customer, and/or to respectively authorize a sale of one or more products purchased by the identified customer based on payment information associated with the customer account. Any customer related data generated during shopping, such as any facial and/or voice recognition data (e.g., training phrases, spoken user passwords, payment information associated with any of the particular customers), may be added to the customer data store 754 and associated with a specific customer account or anonymized and stored for future analysis.

Customer matching may be accomplished utilizing other customer and inventory logics. Matching and authenticating may also be accomplished through the utilizing data received from a customer's mobile computing device in communication with the automated inventory intelligence system 700. By way of a non-limiting example, a customer may enter a store with a mobile phone that is loaded with an application that may create a data connection with the automated inventory intelligence system 700. Upon entering the store, the application may utilize GPS data to determine that the customer is within a store and transmits the data to such system 700. Based upon this data, the automated inventory intelligence system 700 may determine that a particular customer determined to be within the shopping area is the customer associated with the particular customer account. Data regarding the customer's age, height, etc. may be utilized to further match a recognized customer with an account associated with the customer, which may be also utilized to determine whether the recognized customer is associated with payment information that may allow the recognized customer with expedited purchases of products in the retail environment.

Upon matching the customer, all relevant data may be associated between the customer detected within the shopping area, and the customer account info that has been derived. In certain embodiments, the relevant data may include demographics data, shopping history/patterns, age verification data, and/or payment/preauthorization authentication rules which may be associated with an authorized method of payment the customer has set up in their account.

The facial recognition logic 726 may be configured to, upon execution by the processor(s) 702, perform operations to analyze images received by the image receiving logic 718 from the facial recognition cameras 716₁-716ₖ. In some embodiments, the facial recognition logic 726 may look to determine trends in customers based on ethnicity, age, gender, time of visit, geographic location of the store, etc., and, based on additional analysis, the automated inventory intelligence system logic 710 may determine trends in accordance with graphics displayed by the automated inventory intelligence system 700, sales, time of day, time of the year, day of the week, etc. Facial recognition logic 726 may also be able to generate data relating to the overall traffic associated with the facial recognition cameras 716₁-716ₖ. This can be generated directly based on the number of faces (unique and non-unique) that are processed within a given time period. This data can be stored within the persistent storage 706 within a traffic density log 734.

The facial recognition logic 726 and/or the voice recognition logic 727 may be configured to, upon execution by the processors 702, perform operations to analyze images and/or voice samples from at least one or more of any facial recognition cameras 716₁-716ₖ and/or voice recognition sensors 717₁-717ₗ. In the embodiments, the facial recognition logic 726 and/or the voice recognition logic 727 may be utilized to identify customers with their account data such as their personal information and payment information, and to determine trends in the customers based on ethnicity, age, gender, time of visit, geographic location of the store, etc., and, based on additional analysis.

The proximity logic 728 can be configured to, upon execution by the processor(s) 702, perform operations to analyze images received by, for example, the image receiving logic 718 from the proximity sensors 714₁-714ⱼ. In some embodiments, the proximity logic 728 may determine when a customer is within a particular distance threshold from the shelving unit on which the inventory set is stocked and transmit a communication (e.g., instruction or command) to the change the graphics displayed on the fascia, e.g., such as the fascia 711₁-711ₘ. Data related to the proximity, and therefore the potential effectiveness of an advertisement, may be stored within a proximity log 732. In this way, data may be provided that can be tracked with particular displays, products, and/or advertising campaigns. In further embodiments, the proximity logic 728 may work in tandem with the customer matching logic 725 that may be utilized to present specific graphics on intelligent shelves based upon both the proximity data provided by the proximity logic 728 as well as customer-related data from the customer data store 754 from the customer matching logic 725.

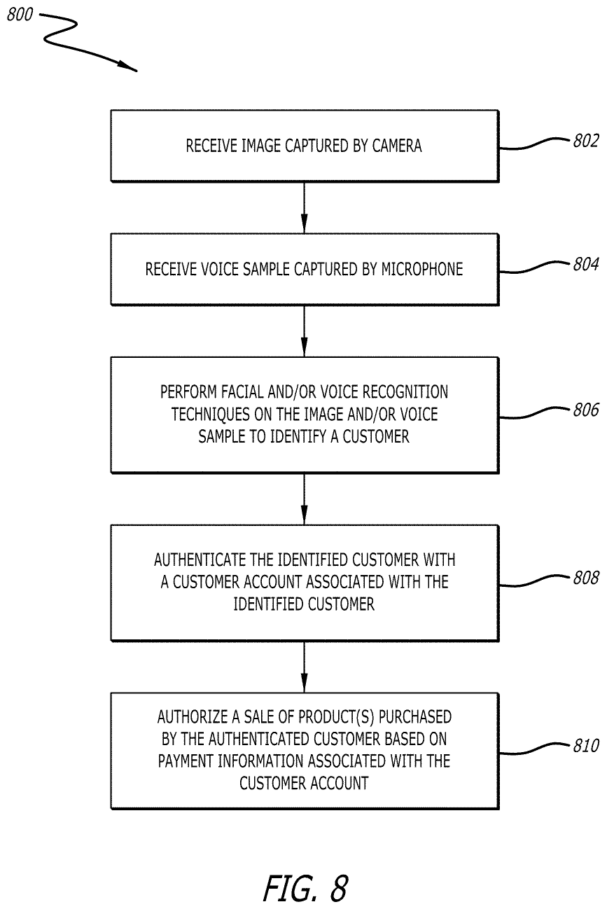

Referring now to FIG. 8, a flowchart illustrating an exemplary method 800 for authenticating the identities of retail customers to facilitate expedited user purchases via an automated inventory intelligence system is shown, in accordance with some embodiments. The method 800 in FIG. 8 may depict one or more illustrations of one or more process flows described herein. For example, in most embodiments, the method 800 may be configured to be configured for authenticating the identities of retail customers to facilitate expedited user purchases. In particular, the method 800 may be configured to use a combination of facial recognition and voice recognition techniques to determine the identity of a retail customer and facilitate expedited purchases of the identified retail customer by implementing an automated inventory intelligence system (or server), as described herein. For example, the automated inventory intelligence system depicted in FIG. 8 may be substantially similar to the automated inventory intelligence system 100 depicted above in FIG. 1 and/or one or more logics of the automated inventory intelligence logic 710 of the automated inventory intelligence system 700 depicted above in FIGS. 7A-B, in accordance with some embodiments.

At block 802, the method 800 may receive one or more images captured by one or more cameras. For example, the automated inventory intelligence system 700 may utilize the image receiving logic 718 of the automated inventory intelligence system logic 710 to receive the one or more images captured by the one or more cameras, such as the inventory cameras 712₁-712ᵢ and/or the facial recognition cameras 716₁-716ₖ. Furthermore, upon receiving the image(s), the facial recognition logic 726 (or one or more other logics, such as the object recognition logic 720) of the automated inventory intelligence system logic 710 may perform processing operations on the captured images to analyze the one or more different captured views and images of the retail customer. For example, the facial recognition logic 726 may receive multiple captured views/images of the retail customer by way of the multiplicity of facial recognition cameras 716₁-716ₖ coupled with a shelving unit or the like (e.g., the shelving unit 102 of FIG. 1), where the multiplicity of facial recognition cameras 716₁-716ₖ and any other cameras may be arranged to capture multiple views of the retail customer.

At block 804, the method 800 may receive one or more voice sample captured by one or more microphones. For example, the automated inventory intelligence system 700 may utilize the automated inventory intelligence system logic 710 to receive the one or more voice samples of the retail customer captured by the one or more microphones, such as the microphones located within the inventory cameras 712₁-712ᵢ, the proximity sensors 714₁-714ⱼ, the facial recognition cameras 716₁-716ₖ, and/or the voice recognition sensors 717₁-717ₖ. Furthermore, upon receiving the voice sample(s), the voice recognition logic 727 (or one or more other logics, such as the image receiving logic 718, the object recognition logic 720, the facial recognition logic 726, and so on) of the automated inventory intelligence system logic 710 may perform processing operations on the captured voice samples to analyze the one or more different captured voice samples of the retail customer. For example, the voice recognition logic 727 of the automated inventory intelligence system logic 710 may operate in combination with the facial recognition logic 726 upon the retail customer speaking a training phrase or a spoken user password that may be captured by the one or more microphones, where the voice recognition logic 727 may receive the multiple captured voice samples by way of a multiplicity of microphones that are coupled with the shelving unit, and where the microphones may be arranged into an advantageous microphone (or audio) geometry for capturing and identifying the voice of the retail customer. It should be understood that any number of blocks and/or any desired order of steps may be implemented prior to proceeding to the authentication step depicted at block 806, without limitations. For example, the method 800 may be configured to initially receive a voice sample from a customer at block 802 and then proceed to receive an image from the customer at block 804, without limitation. In another example, the method 800 may be configured to only receive a voice sample from a customer at block 802 and then proceed to block 806—without receiving an image from the customer—to authenticate and identify the customer based on the received voice sample, without limitation.

At block 806, the method 800 may perform one or more facial and/or voice recognition techniques on the one or more images and/or voice samples to identify a particular customer. It should be appreciated and understood that the method 800 may perform the authentication and recognition operations to identify a particular customer in a variety of orders, such as (i) receiving the image prior to receiving the voice sample in order to initiate the authentication process, (ii) receiving the voice sample prior to receiving the image in order to initiate the authentication process, (iii) receiving only one of the image or the voice sample in order to initiate the authentication process, and (iv) any other order that may be desired to initiate the authentication process. For example, the automated inventory intelligence system 700 may utilize the automated inventory intelligence system logic 710 to perform one or more facial and/or voice recognition techniques on the one or more captured images and/or voice samples to identify and match the particular customer from all other customers in the retail store.

In particular, the customer matching logic 725 of the automated inventory intelligence system logic 710 may be used to identify the customer based on at least one or more of the captured images and voice samples particularly stored in the customer data store 754, where the customer matching logic 725 may be configured to also match the identified customer with a customer account associated with the identified customer. As described above, the customer data sore 754 in conjunction with the customer matching logic 725 may be utilized for a variety of operations that store various customer data points associated with each particular customer and their one or more respective retail stores. For example, the customer data store 754 may include, but is not limited to, determining trends of the customers or gathering data related to the customers based on ethnicity, vocal ascent, key phrases, particular facial characteristics, age, gender, time of visit, geographic location of the store, and so on. As such, the method 800 may be particularly configured to access any variety of customer information, accounts, facial images, voice samples, and so on, that are particularly stored within the customer data store 754, where such particular customer data store may be utilized by the method 800 to identify any particular customer recognized within a retail store based on at least one or more of the captured images and voice samples, match the identified customer with a customer account associated with the identified customer, and/or respectively authorize one or more product purchase by the identified customer based on payment information associated with the customer account. Any customer related data generated during shopping, such as any facial and/or voice recognition data (e.g., training phrases, spoken user passwords, payment information associated with any of the particular customers), may be added to the customer data store 754 and associated with a specific customer account or anonymized and stored for future analysis.

At block 808, the method 800 may authenticate the identified customer with a customer account associated with the identified customer. For example, the automated inventory intelligence system 700 may utilize the automated inventory intelligence system logic 710 to authenticate the identified retail customer with the particular customer account associated with the particular identified customer, where the customer matching logic may include a two-stage authentication system (or operation) that may include a combination of the facial recognition logic and the voice recognition logic. That is, it is envisioned that, in some embodiments, each of the facial recognition and the voice recognition may include one or more layers of authentication if desired, without limitation.

At block 810, the method 800 may authorize a sale of one or more products purchased by the authenticated customer based on payment information associated with the customer account. For example, the automated inventory intelligence system 700 may utilize the automated inventory intelligence system logic 710 to provide authentication and make the account of the retail customer accessible to the identified customer, whereby the identified retail customer may perform expedited purchases directly at the shelving unit by utilizing the payment information and drawing upon the funds of the payment information stored in the customer's account. That is, the automated inventory intelligence system logic 710 may be configured to authorize a sale of one or more products purchased by the identified customer based on payment information associated with the customer account.

Information as shown and described in detail herein is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail may be made, without departing from the spirit and scope of the present disclosure, as set forth in the appended claims, as might be apparent to those of ordinary skill in the art, are also encompassed by the present disclosure.

What is claimed is:

1. An automated inventory intelligence system to facilitate expedited purchases, comprising:
one or more cameras;
one or more sensors;
a processor communicatively coupled to the one or more cameras and sensors; and
a memory communicatively coupled to the processor, the memory comprising:
a facial recognition logic to receive one or more images captured with the one or more cameras;
a voice recognition logic to receive one or more voice samples captured with one or more sensors;
a customer matching logic to identify a customer based on at least one or more of the captured images and voice samples, wherein the customer matching logic is configured to match the identified customer with a customer account associated with the identified customer; and
an automated inventory intelligence system logic to authorize a sale of one or more products purchased by the identified customer based on payment information associated with the customer account.

2. The automated inventory intelligence system of claim 1, wherein the one or more cameras and sensors are coupled to a shelving unit.

3. The automated inventory intelligence system of claim 2, wherein the voice recognition logic is configured to operate in combination with the facial recognition logic, and wherein the one or more sensors include one or more microphones that are coupled with the shelving unit.

4. The automated inventory intelligence system of claim 3, wherein the one or more microphones are positioned on the shelving unit in a predetermined audio geometry to optimally capture the one or more voice samples of the customer.

5. The automated inventory intelligence system of claim 4, wherein the voice recognition logic is configured to receive the captured voice sample upon the customer speaking a training phrase or a spoken user password, and wherein the one or more microphones are configured to capture the training phrase or the spoken user password of the customer.

6. The automated inventory intelligence system of claim 3, wherein the facial recognition logic is configured to receive the one or more images having a plurality of views of the customer.

7. The automated inventory intelligence system of claim 6, wherein the one or more cameras include one or more facial recognition cameras that are coupled with the shelving unit, and wherein the one or more facial recognition cameras are positioned on the shelving unit in a predetermined visual geometry to optimally capture the plurality of views of the customer.

8. The automated inventory intelligence system of claim 2, wherein the customer matching logic is further configured to authenticate the customer with an authentication operation that utilizes the at least one or more of the captured images and voice samples, wherein the authentication operation is further configured to authenticate the customer in conjunction with the payment information of the customer account, wherein the authenticated payment information of the authenticated customer is used for the expedited purchases of the one or more products that are directly purchased at the shelving unit, and wherein the payment information of the customer account is securely stored in a retail customer data store associated with the shelving unit.

9. The automated inventory intelligence system of claim 8, wherein the authentication operation includes a two-stage authentication operation, and wherein the two-stage authentication operation includes a combination of the facial recognition logic and the voice recognition logic.

10. A method for identifying customers to facilitate expedited purchases, the method comprising:
receiving an image captured with a camera;
receiving a voice sample captured with a sensor;
identifying a customer based on at least one of the captured image and the voice sample;
matching the identified customer with a customer account associated with the identified customer; and
authorizing a sale of a product purchased by the identified customer based on payment information associated with the matched customer account.

11. The method of claim 10, wherein the camera and sensor are coupled to a shelving unit, and wherein the sensor includes a microphone that is coupled with the shelving unit.

12. The method of claim 11, wherein the microphone is positioned on the shelving unit in a predetermined audio geometry to optimally capture the voice sample of the customer.

13. The method of claim 12, wherein receiving the voice sample further includes receiving the voice sample upon the customer speaking a training phrase or a spoken user password, and wherein the microphone is configured to capture the training phrase or the spoken user password of the customer.

14. The method of claim 13, wherein the captured image includes one or more views of the customer.

15. The method of claim 14, wherein the camera includes a facial recognition camera that is coupled with the shelving unit, and wherein the facial recognition camera is positioned on the shelving unit in a predetermined visual geometry to optimally capture the one or more views of the customer.

16. The method of claim 15, further comprising authenticating the customer with an authentication operation that utilizes at least the one of the captured image and voice sample, wherein the authentication operation is further configured to authenticate the customer in conjunction with the payment information of the customer account, wherein the authenticated payment information of the authenticated customer is used for the expedited purchases of the product that is directly purchased at the shelving unit, and wherein the payment information of the customer account is securely stored in a retail customer data store associated with the shelving unit.

17. The method of claim 16, wherein the authentication operation includes a two-stage authentication operation, and wherein the two-stage authentication operation includes a combination of a facial recognition logic and a voice recognition logic.

18. An automated inventory intelligence system to facilitate expedited purchases, comprising:
one or more facial recognition cameras;
one or more microphones;
an intelligent shelving unit coupled to the one or more facial recognition cameras and microphones;
one or more processors communicatively coupled to the intelligent shelving unit; and
a memory communicatively coupled to the one or more processors, the memory comprising:
a facial recognition logic to receive one or more images captured with the one or more facial recognition cameras;
a voice recognition logic to receive one or more voice samples captured with one or more microphones;
a customer matching logic to identify a customer based on at least one or more of the captured images and voice samples, wherein the customer matching logic is configured to match the identified customer with a customer account associated with the identified customer, and wherein the customer matching logic is configured to authenticate the customer in conjunction with the payment information of the customer account via an authentication operation; and
an automated inventory intelligence system logic to authorize a sale of one or more products purchased by the identified customer directly at the intelligent shelving unit based on payment information associated with the customer account, wherein the authenticated payment information of the authenticated customer is used for the expedited purchases of the one or more products that are directly purchased at the shelving unit.

19. The automated inventory intelligence system of claim 18, wherein the voice recognition logic is configured to operate in combination with the facial recognition logic.

20. The automated inventory intelligence system of claim 18, wherein the authentication operation utilizes at least the one or more of the captured images and voice samples, and wherein the payment information of the customer account is securely stored in a retail customer data store associated with the shelving unit.
